(19) United States
(12) Patent Application Publication
(10) Pub. No.: US 2011/0105236 A1
(43) Pub. Date: May 5, 2011

(54) Universal joint for steering mechanism for automobiles

(76) Inventor: Melchor Daumal Castellon, Barcelona (ES)

(21) Appl. No.: 12/311,244

(22) PCT Filed: Oct. 31, 2006
(86) PCT No.: PCT/ES2006/000602

§ 371 Date: Mar. 24, 2009

(30) Foreign Application Priority Data
Sep. 29, 2006 (ES) 200602487

(51) Int. Cl. F16D 3/38

(52) U.S. Cl. 464/132

(57) ABSTRACT

The invention refers to a fork specially designed to ensure that the ends or heads of the crosstree are located inside the bushing where these heads plus an anti-friction sleeve are housed. These are preferably made from a plastic material or similar, in the Teflon group of plastics giving some form of elasticity to the aforementioned sleeve. The invention has the aim of absorbing possible misalignment when the rotating shafts are joined by universal joints.

This Invention patent application is as indicated in the title “IMPROVED UNIVERSAL JOINT FOR STEERING MECHANISMS IN CARS”, the new construction, shape and design features of which fulfill the purpose for which it has been specifically designed with maximum safety and effectiveness.

More specifically the invention refers to a fork specially designed to ensure that the ends or heads of the crosstree are located inside the bushing where these heads plus an anti-friction sleeve are housed. These are preferably made from a plastic material or similar, in the Teflon group of plastics giving some form of elasticity to the aforementioned sleeve.

The invention has the aim of absorbing possible misalignment when the rotating shafts are joined by universal joints. As is known these joints transfer this rotation without difficulty. In addition it compensates for differences in distances and lengths such as those difference which are produced between the steering wheel and the steering box in steering mechanisms.

Universal joints are formed by crosstrees which in this case are on the spherical heads. The arms of these crosstrees are jointed in a fork where a shaft terminates and the fork of the other shaft in the other arm. The crosstree head joints on the ends of these shafts have the relevant housings inside which are sleeves. Between these bushings there are spherical heads with also semi-spherical sleeves.

The function of the housing for this type of universal joint is to match the crosstree head to the housing between the fork arms so that it is completely flexible and where possible avoiding high levels of friction. The improvements in this invention add the function of the sleeve being an intermediate part between the housing and crosstree head with a high degree of flexibility. This allows not only the movement of the universal joint and also the absorption of misalignment between drive shafts joined by a universal joint without distorting the uniformity of movement transmission between the aforementioned shafts in a conventional steering mechanism.

As an additional part, these improvements may include a plug in the housing's opening which closes off the bushing to prevent dirt and dust from entering. This dust and dirt damages the sleeve's elastic and low friction properties covering its outward facing side.

The improved universal joint shall include the following components:
A fork.
A housing for the bushing.
An anti-friction bushing
An elastic sleeve.

The elastic sleeve has Teflon on the outward facing side of the bushing and is pressed into the preferably metal housing. With such housing on a diametral plane it is held by welding the arms on the relevant fork.

Other details and characteristics shall be shown throughout the description below referring to drawing attached to this report which is shown for illustrative but not limiting purposes a preferred embodiment of the invention.

Below is a list of the main parts in the invention showing the number in the attached diagram; (10) universal joint, (11) fork, (12) arms of the fork, (13) housing, (14) bushing, (15) sleeve, (16) fork, (17) arms of the fork, (18) housing, (19) sleeve, (20) sleeve, (21) plug, (22-23) shafts, (24) opening, (25-26) heads, (27) crosstrees.

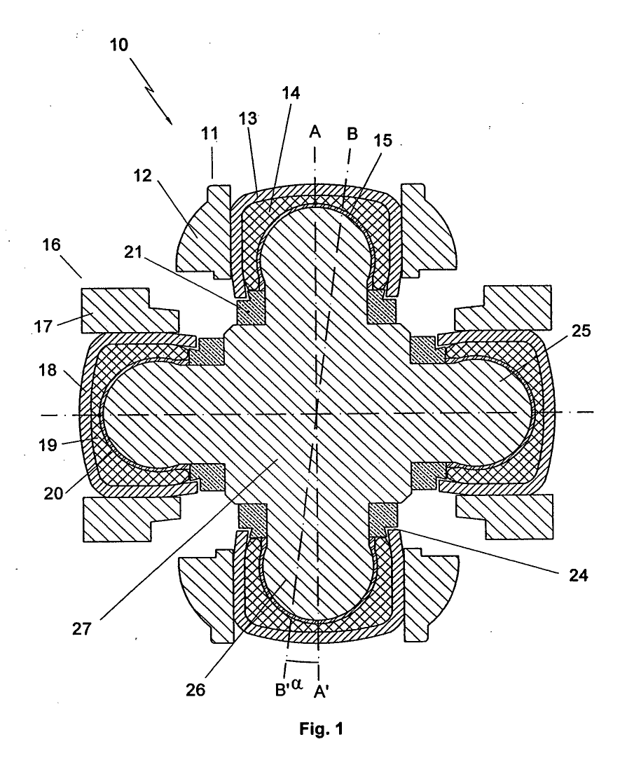

FIG. 1 is a longitudinal cross section plan view of a universal joint in accordance with one set up for the invention.

In one of the preferred set ups which is the purpose of this invention the joint (10) is formed by the forks (11-16) located at the ends of the shafts (22-23), not shown in the figure, the arms (12-17) of the forks (11-16) encompass a diametral plane of the housing (13-18), with bushings (14-19) on the inside of these housings which are coated on their outward facing side by anti-friction bushings (15-20), closing off the opening (24) with a plug (21).

On the inside of the hole delineated by the semi-spherical bushings (15-20) the crosstree (27) spherical heads (25-26) are pressed in and aligned on orthogonal planes, see FIG. 1.

In one application of the invention and its main aim, the shafts to be joined (22-23) are aligned as in FIG. 1 along the axis B-B′, whereas the universal joint (10) is aligned along A-A′. Therefore for the joint to work properly, it must be able to withstand a misalignment the magnitude of which is the alpha angle shown in this diagram. This is achieved by fitting semi-spherical anti-friction sleeves (15-20) the flexibility of which can absorb the alpha angle and can correct the misalignment between these shafts (22-23).

Having sufficiently described this invention using the attached drawing, it is easy to understand that any changes judged to be suitable may be made, whenever these changes do not alter of the essence of the invention summarised in the following claims.

1. “IMPROVED UNIVERSAL JOINT FOR STEERING MECHANISMS IN CARS”, which is formed by forks (11-16), whose arms (12-17) have housings (13-18), inside which are bushings (14-19), on the surface of which the heads (25-26) of the crosstrees (27) are located, characterised by the fact that covering the outward side of the bushing (14- 19) there are semi-spherical sleeves (15-20) made form anti-friction material.

2. “IMPROVED UNIVERSAL JOINT FOR STEERING MECHANISMS IN CARS”, according to the claim 1 characterised by the fact that the semi-spherical sleeves (15-20) are made from a Teflon based material.

3. “IMPROVED UNIVERSAL JOINT FOR STEERING MECHANISMS IN CARS”, according to the claim 1 characterised by the fact that in the shafts (24) of the housings (13-18) the sleeve (21) is assembled.
